(19) United States
(12) Patent Application Publication
(10) Pub. No.: US 2026/0175924 A1
(43) Pub. Date: Jun. 25, 2026

(54) VEHICLE BODY STRUCTURE

(71) Applicants: Hyundai Motor Company, Seoul (KR); Kia Corporation, Seoul (KR)

(72) Inventor: Soo Heung Eom, Hwaseong-si (KR)

(21) Appl. No.: 19/085,095

(22) Filed: Mar. 20, 2025

(30) Foreign Application Priority Data
Dec. 20, 2024 (KR) 10-2024-0192957

(51) Int. Cl. B62D 25/14; B60R 16/04; B62D 21/15; B62D 25/02; H01M 50/242; H01M 50/249

(52) U.S. Cl. CPC B62D 25/145; B60R 16/04; B62D 21/157; B62D 25/025; H01M 50/242; H01M 50/249; H01M 2220/20

(57) ABSTRACT

A vehicle body structure can include a dash panel, a side sill including a first side sill and a second side sill, respectively connected to both sides of the dash panel, a first cross member located above the side sill and coupled to the dash panel, a second cross member coupled to the dash panel and connected to the side sill, and a connection member connecting the first cross member and the second cross member, wherein the connection member includes a first connection member and a second connection member, wherein the second connection member is spaced apart from the first connection member.

### CROSS-REFERENCE TO RELATED APPLICATIONS

This application claims benefit of priority to Korean Patent Application No. 10-2024-0192957 filed on Dec. 20, 2024 in the Korean Intellectual Property Office, the disclosure of which is incorporated herein by reference in its entirety.

### TECHNICAL FIELD

The present disclosure relates to a vehicle body structure.

### BACKGROUND

As interest in eco-friendly vehicles has increased, interest in electric vehicles has also naturally increased. In electric vehicles, structural stability safely supporting a battery and safely absorbing impacts in the occurrence of a collision should be ensured, and replacement, repair, or the like, of the battery, should be easily possible.

In the past, because structural rigidity of a vehicle was secured by an adhesive between the battery and a different structure of the vehicle, there were problems such as the battery being impossible to repair or having insufficient sealing ability, and the battery being damaged due to insufficient structures to receive impacts when the vehicle was impacted in a lateral direction.

To solve these problems, it is necessary to develop a vehicle body structure that may effectively connect a vehicle body and a battery pack and may sufficiently secure rigidity of the vehicle.

### SUMMARY

The present disclosure relates to a vehicle body structure including a first cross member and a second cross member, spaced apart from each other in a diagonal direction.

To solve at least some of the above described problems, a vehicle body structure of an embodiment of the present disclosure may include a first cross member and a second cross member to improve side collision stability.

A vehicle body structure of an embodiment of the present disclosure can provide a structure capable of absorbing impacts by locating a triple structure in a position in which a rotational moment caused by a collision load can be large.

A vehicle body structure of an embodiment of the present disclosure can provide a structure capable of dispersing stress applied to a triple structure by a connection member and a side lower member.

A vehicle body structure of an embodiment of the present disclosure can provide a structure capable of reducing weight of a vehicle and improving air-tightness performance by simplifying a sealing surface of a battery pack.

According to an embodiment of the present disclosure, a vehicle body structure can include: a dash panel; a side sill including a first side sill and a second side sill, respectively connected to both sides of the dash panel; a first cross member located above the side sill and coupled to the dash panel; a second cross member coupled to the dash panel and connected to the side sill; and a connection member connecting the first cross member and the second cross member, wherein the connection member includes a first connection member; and a second connection member spaced apart from the first connection member.

The first cross member and the second cross member may be coupled to the dash panel, a level of the first cross member may be higher than a level of the second cross member, and the first cross member and the second cross member may be spaced apart in an extension direction of the side sill.

A vehicle body structure may further include a third cross member spaced apart from the second cross member, where a battery space may be provided between the first side sill and the second side sill, a battery pack installed in the battery space may be further included, and the third cross member may be coupled to an upper surface of the battery pack.

A vehicle body structure may further include a third connection member connecting the first cross member, the second cross member, and the third cross member, where the third connection member may penetrate the second cross member.

The third connection member may be located between the first connection member and the second connection member.

A vehicle body structure may further include a fourth cross member overlapping the second cross member below the second cross member.

The fourth cross member may be connected to the first side sill and the second side sill, and a lower surface of the fourth cross member, a lower surface of the first side sill, and a lower surface of the second side sill may form a sealing surface having a constant level.

A vehicle body structure may further include a battery pack located between the first side sill and the second side sill, where the battery pack may overlap the sealing surface, and may be connected to the fourth cross member.

A vehicle body structure may further include a side lower member coupled to the fourth cross member, where the side lower member may have a branching region, and may be connected to the fourth cross member in a plurality of regions.

The side lower member may include a first side lower member; and a second side lower member spaced apart from the first side lower member.

A vehicle body structure may further include a subframe mounting member connected to the dash panel; and a front subframe connected to the subframe mounting member below the first cross member.

The subframe mounting member may extend in a diagonal direction.

The first cross member may extend in a first direction, and the front subframe and the fourth cross member may be spaced apart in a second direction, intersecting the first direction.

### BRIEF DESCRIPTION OF THE DRAWINGS

Features and advantages of example embodiments of the present disclosure can be more clearly understood from the following detailed description, taken in conjunction with the accompanying drawings, in which:

FIG. 1 is a perspective view illustrating a vehicle body structure according to an embodiment of the present disclosure;

FIG. 2 is an exploded perspective view illustrating a vehicle body structure according to an embodiment of the present disclosure;

FIG. 3 is an enlarged perspective view illustrating a portion of a vehicle body structure according to an embodiment of the present disclosure;

FIG. 4 is a side view illustrating a vehicle body structure according to an embodiment of the present disclosure;

FIG. 5 is an enlarged side view illustrating a portion of a vehicle body structure according to an embodiment of the present disclosure;

FIG. 6 is a bottom view illustrating a vehicle body structure according to an embodiment of the present disclosure; and

FIG. 7 is an enlarged bottom view illustrating a portion of a vehicle body structure according to an embodiment of the present disclosure.

### DETAILED DESCRIPTION OF ILLUSTRATIVE EMBODIMENTS

Because the present disclosure may have various changes and may have various embodiments, specific example embodiments are illustrated in the drawings and described in detail. However, this is not intended to necessarily limit the present disclosure to specific example embodiments, and the present disclosure can be understood to include all modifications, equivalents, and substitutes for other embodiments included in the spirit and scopes of the present disclosure.

Terms such as “first,” “second,” etc. may be used to describe various elements, but the elements are not necessarily limited by such terms, and elements are not necessarily limited in order, size, location, or importance by such terms. Such terms may be used only for the purpose of distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

Terms used in the present application may be used to describe specific example embodiments, and may not be intended to necessarily limit the present disclosure. A singular expression may include a plural expression unless the context clearly dictates otherwise. In the present disclosure, terms such as “comprise,” “include,” “have,” and the like are intended to designate that a feature, a number, an operation, an operation, a component, a part, or a combination thereof described in the specification exists, but it should be understood that there can be existence or addition of one or more other features, numbers, operations, components, parts, or combinations thereof.

Unless defined otherwise, terms used herein, including technical or scientific terms, can have same meanings as commonly understood by one of ordinary skill in the art to which the present disclosure belongs. Terms such as those defined in a commonly used dictionary can be interpreted as having meanings consistent with meanings in the context of the related art.

In the description below, the terms “in front of,” “a front portion,” “behind,” “a rear portion,” “lateral,” “side,” “forward,” “rearward,” “vertical (direction),” “on,” “upper,” “an upper portion,” “below,” “lower,” “a lower portion,” “left and right,” or the like, can be used in relation to a direction, and may be defined based on a vehicle or a vehicle body.

Hereinafter, with reference to the attached drawings, example embodiments of the present disclosure will be described in more detail.

In the drawings, D1 may be referred to as a first direction, D2 intersecting the first direction D1 may be referred to as a second direction, and D3 intersecting the first direction D1 and the second direction D2 may be referred to as a third direction. The third direction D3 may be referred to as an upward direction, and a direction, opposite to the third direction D3, may be referred to as a downward direction. The first direction D1 and the second direction D2 may be referred to as horizontal directions.

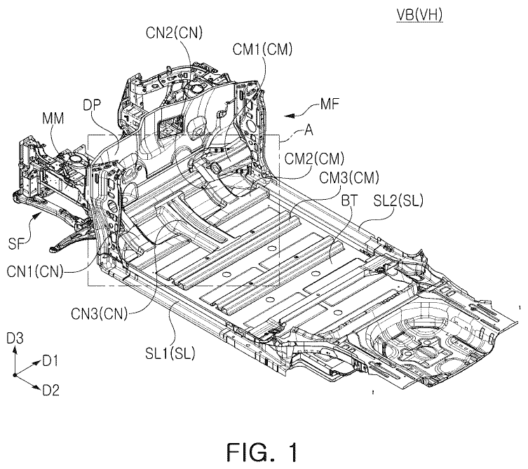

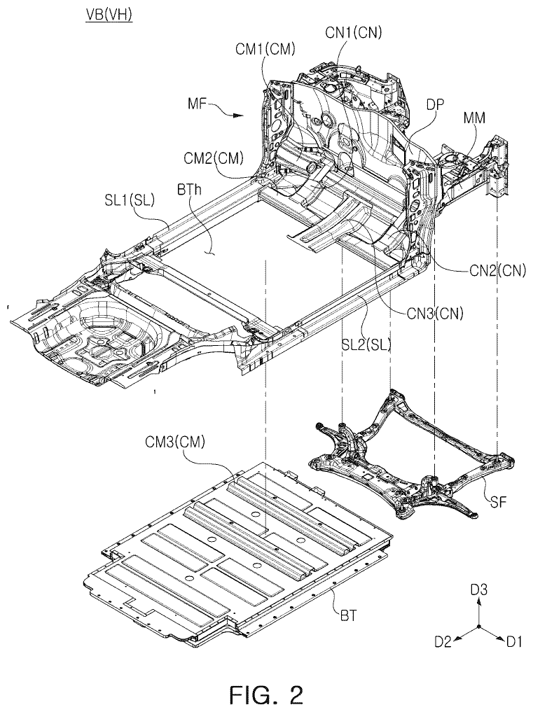

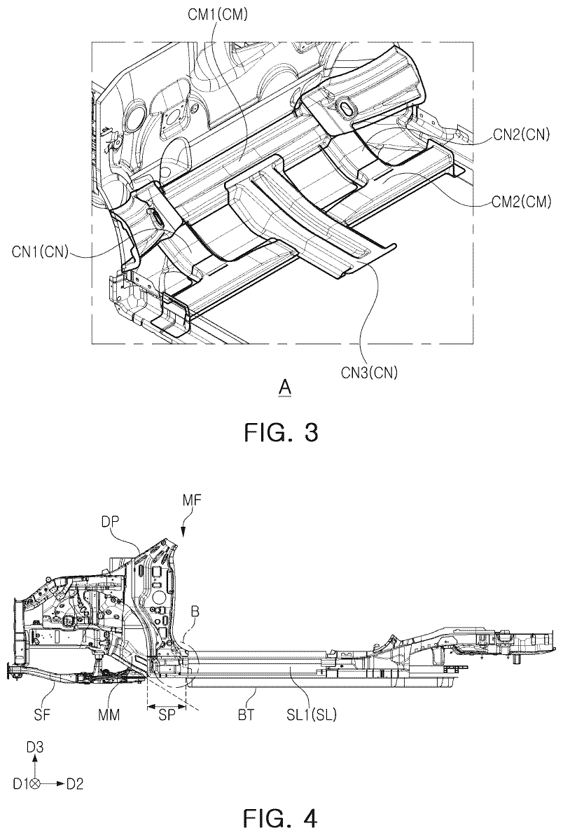

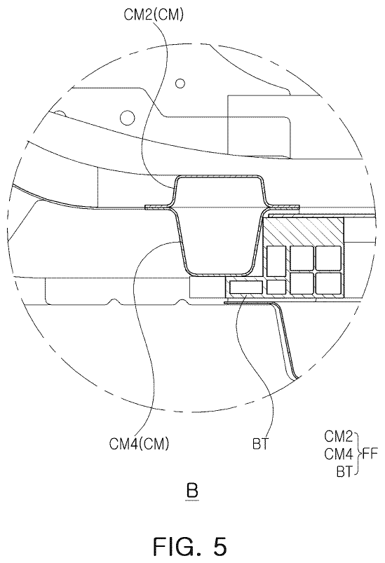

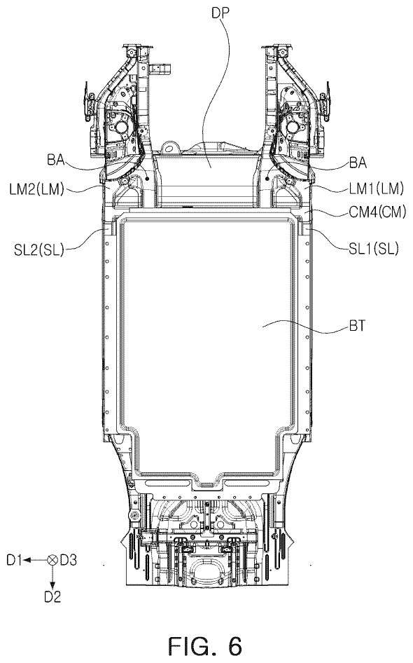

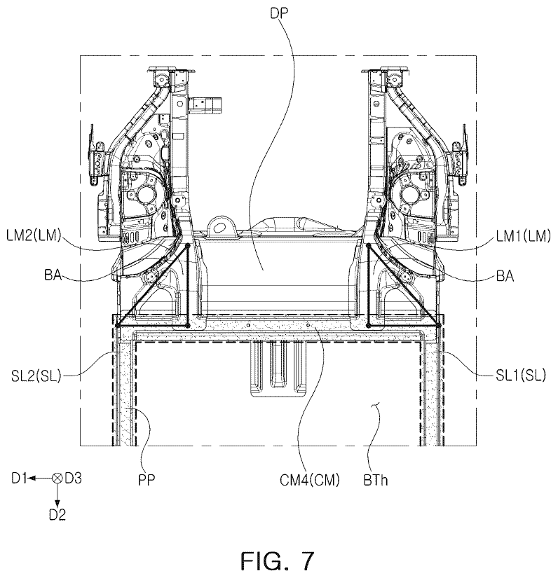

FIG. 1 is a perspective view illustrating a vehicle body structure VB according to an embodiment of the present disclosure. FIG. 2 is an exploded perspective view illustrating a vehicle body structure VB according to an embodiment of the present disclosure. FIG. 3 is an enlarged perspective view illustrating a portion of a vehicle body structure VB according to an embodiment of the present disclosure. FIG. 4 is a side view illustrating a vehicle body structure VB according to an embodiment of the present disclosure. FIG. 5 is an enlarged side view illustrating a portion of a vehicle body structure VB according to an embodiment of the present disclosure. FIG. 6 is a bottom view illustrating a vehicle body structure VB according to an embodiment of the present disclosure. FIG. 7 is an enlarged bottom view illustrating a portion of a vehicle body structure VB according to an embodiment of the present disclosure.

A vehicle body structure VB may support various devices or the like installed in a vehicle VH. For example, the vehicle body structure VB may be coupled to and support various components such as a seat, various electronic devices used for driving the vehicle VH, a console, a vehicle wheel, a suspension, or the like. Referring to FIGS. 1, 2, and 3, a vehicle body structure VB according to an embodiment may include a main frame MF and a battery pack BT. FIG. 3 is an enlarged view of portion A of the vehicle body structure VB in FIG. 1 for an example embodiment. A main frame MF according to an embodiment may include a dash panel DP, a side sill SL, a cross member CM, a side lower member LM, and a connection member CN. A vehicle body structure VB according to an embodiment may optionally include a front subframe SF and a subframe mounting member MM.

The dash panel DP may serve as a wall physically partitioning an engine room of the vehicle VH and a cabin, which may be a space in which a passenger boards. The dash panel DP may be located in a front portion of the vehicle VH. The dash panel DP may block heat, noise, vibration, or the like of the engine room to ensure the passenger safety. The dash panel DP may absorb and disperse impact in occurrence of a front collision or a side collision, to minimize deformation of the cabin. The dash panel DP may be coupled to various components such as a heating-ventilation-and-air-conditioning (HVAC) system, a steering column, or the like, to provide stability and convenience to a driver. The dash panel DP may be coupled to a side sill and an A-pillar of the vehicle VH. The dash panel DP may include one of or any combination of a high-strength steel material, an aluminum alloy, or a composite material, but is not necessarily limited thereto.

The side sill SL may be a component extending along a lower outer edge of the vehicle body structure VB. The side sill SL may be connected to both bottom edges of the cabin. The side sill SL may connect an interior component and an exterior door frame in the vehicle VH. The side sill SL may protect the passenger by dispersing and absorbing collision energy in occurrence of a side collision of the vehicle VH. The side sill SL may transfer load of the vehicle VH to the battery pack BT, the front subframe SF, or the like, to secure balance and structural stability of the vehicle VH.

The side sill SL may be connected to the dash panel DP. The side sill SL may include a first side sill SL1 and a second side sill SL2, connected to the dash panel DP. The first side sill SL1 may be connected to one side of the dash panel DP. The second side sill SL2 may be connected to the other side of the dash panel DP. The first side sill SL1 and the second side sill SL2 may be spaced apart in a first direction D1. The first side sill SL1 and the second side sill SL2 may extend in a second direction D2, intersecting the first direction D1.

The battery pack BT may supply power by converting chemical energy into electrical energy to a driving motor, electric/electronic components, or the like of the vehicle VH. The battery pack BT may control voltage, current, temperature, or the like in real time through a battery management system (BMS). The battery pack BT may include a cell, an internal insulator, a cooling channel, a battery housing, or the like. The cell may be a basic structure of the battery pack BT including a positive electrode, a negative electrode, an electrolyte, a separator, and the like, and may convert chemical energy into electrical energy and may release or store the same. Depending on a shape of a cell package surrounding the cell, the cell package may include one of a square shape, a cylindrical shape, or a pouch shape, but the shape of the cell package is not necessarily limited thereto.

Referring to FIGS. 1 and 2, a space between the first side sill SL1 and the second side sill SL2 may be a battery space BTh. The battery space BTh may be located in a lower region of the vehicle body structure VB. The battery pack BT may be located in the battery space BTh. At least a portion of the battery pack BT may be located in the battery space BTh. The battery pack BT may be located at a lower portion of the vehicle VH, and may serve to lower a center of gravity of the vehicle VH, which may improve driving stability of the vehicle VH. Energy may be dispersed in occurrence of a collision of the vehicle VH by the battery pack BT. A coupling relationship between the battery pack BT and other components in the vehicle body structure VB will be described below.

Referring to FIGS. 1, 2, 3, and 5, a cross member CM may extend in the first direction D1. FIG. 5 is a perspective view illustrating portion B of FIG. 4, as an example embodiment. A cross member CM may protect the passenger from a side collision. A cross member CM according to an embodiment may include one of or any combination of a first cross member CM1, a second cross member CM2, a third cross member CM3, or a fourth cross member CM4.

The first cross member CM1 may be coupled to the dash panel DP. The first cross member CM1 may be connected to an A-pillar. The first cross member CM1 may connect an A-pillar connected to both sides of the dash panel DP. The first cross member CM1 may be located on the side sill SL. A level of the first cross member CM1 may be higher than a level of the side sill SL.

The second cross member CM2 may be coupled to the dash panel DP. The second cross member CM2 may be connected to the side sill SL. The second cross member CM2 may be connected to the first side sill SL1 and the second side sill SL2. Referring to FIGS. 1 and 2, the first cross member CM1 and the second cross member CM2 may be spaced apart from each other in a diagonal direction, and may be connected to the dash panel DP. In the present specification, a diagonal direction may be a direction including both the third direction D3 and the second direction D2, for example. The first cross member CM1 may be located in an intermediate region of the dash panel DP. The second cross member CM2 may be located in a lower region of the dash panel DP. The first cross member CM1 and the second cross member CM2 may be spaced apart in the third direction D3. The level of the first cross member CM1 may be higher than a level of the second cross member CM2. The first cross member CM1 and the second cross member CM2 may be spaced apart in the second direction D2. The first cross member CM1 may be located in front of the second cross member CM2 in the vehicle VH.

The third cross member CM3 may be coupled to the battery pack BT. The third cross member CM3 may be coupled to an upper surface of the battery pack BT. The third cross member CM3 may protect the passenger from an external force applied in the first direction D1, together with a battery housing of the battery pack BT.

Referring to FIGS. 5, 6, and 7, the fourth cross member CM4 may extend in the first direction D1. The fourth cross member CM4 may be coupled to the second cross member CM2. The fourth cross member CM4 may connect the first side sill SL1 and the second side sill SL2. The fourth cross member CM4 and the side sill SL may form a sealing surface PP. More specifically, a lower surface of the fourth cross member CM4, a lower surface of the first side sill SL1, and a lower surface of the second side sill SL2 may form the sealing surface PP. The lower surface of the fourth cross member CM4, the lower surface of the first side sill SL1, and the lower surface of the second side sill SL2 may be on the same level. The sealing surface PP may have a constant level.

Referring to FIG. 5, the fourth cross member CM4 may be located below the second cross member CM2. The fourth cross member CM4 may overlap the second cross member CM2 below the second cross member CM2. At least a portion of the battery pack BT may be located below the fourth cross member CM4. At least a portion of the battery pack BT may overlap the sealing surface PP below the sealing surface PP. As the sealing surface PP having a certain level and the battery pack BT are coupled, a method of coupling the battery pack BT and other components of the vehicle body structure VB may be simplified, and sealing force of the battery pack BT may increase.

The vehicle body structure VB may form a triple frame FF by the second cross member CM2, the fourth cross member CM4, and the battery pack BT. An empty space may be provided between the second cross member CM2 and the fourth cross member CM4. The second cross member CM2 and the fourth cross member CM4 may form a hollow pocket structure. The vehicle body structure VB may have the triple frame FF formed by the second cross member CM2, the fourth cross member CM4, and the battery pack BT, to protect the passenger from collision energy generated when the vehicle VH collides. The triple frame FF may be connected to the side sill SL. The triple frame FF may absorb collision energy to reduce deformation of the vehicle body structure VB.

A connection member CN may support the triple frame FF. A connection member CN may disperse at least a portion of impact applied to the triple frame FF. A connection member CN may extend in the second direction D2. A connection member CN may connect the cross member CM. A plurality of cross members CM may be connected by a connection member CN. A connection member CN according to an embodiment may include a first connection member CN1, a second connection member CN2, and a third connection member CN3.

The first connection member CN1 may connect the first cross member CM1 and the second cross member CM2. The first connection member CN1 may extend in a diagonal direction in which the first cross member CM1 and the second cross member CM2 are spaced apart. The first connection member CN1 may not have a constant inclination.

The second connection member CN2 may be spaced apart from the first connection member CN1 in the first direction D1. The second connection member CN2 may extend in a diagonal direction in which the first cross member CM1 and the second cross member CM2 are spaced apart. The second connection member CN2 may not have a constant inclination. An extension direction of the second connection member CN2 may be equal to an extension direction of the first connection member CN1, but is not necessarily limited thereto.

The first connection member CN1, the second connection member CN2, the first cross member CM1, and the second cross member CM2 may have an II shape. The first connection member CN1, the second connection member CN2, the first cross member CM1, and the second cross member CM2 may have a ladder shape. Collision energy or stress applied to the triple frame FF in collision of the vehicle VH may be distributed by the first connection member CN1, the second connection member CN2, the first cross member CM1, and the second cross member CM2.

The third connection member CN3 may connect the first cross member CM1, the second cross member CM2, and the third cross member CM3. The third connection member CN3 may be located between the first connection member CN1 and the second connection member CN2. The third connection member CN3 may penetrate the second cross member CM2. The third connection member CN3 may extend in the second direction D2. At least a portion of the third connection member CN3 may extend in a diagonal direction in which the first cross member CM1 and the second cross member CM2 are spaced apart. A width of the third connection member CN3 may be wider than a width of each of the first connection member CN1 and a width of the second connection member CN2, but is not necessarily limited thereto.

Referring to FIGS. 6 and 7, a side lower member LM may be coupled to the fourth cross member CM4. For convenience of explanation, FIGS. 6 and 7 do not illustrate the front subframe SF. A side lower member LM may be provided as a plurality of side lower members LM. More specifically, a side lower member LM may include a first side lower member LM1 and a second side lower member LM2. The first side lower member LM1 and the second side lower member LM2 may be spaced apart in the first direction D1. Hereinafter, the plurality of side lower members LM may be treated and described as a single side lower member LM. Contents of the side lower member LM may be equally applied to the first side lower member LM1 and the second side lower member LM2, respectively.

The side lower member LM may be connected to the side sill SL. At least a portion of the side lower member LM may be located below the side sill SL. The side lower member LM may meet the fourth cross member CM4 in a plurality of regions. The side lower member LM may extend from the fourth cross member CM4 in a diagonal direction. The side lower member LM may have a branching region BA. An arm of the side lower member LM may be divided to have multiple numbers in the branching region BA. In the present specification, the side lower member LM may have two arms by the branching region BA. However, this is an illustrative example, and the number of arms of the side lower member LM divided by the branching region BA is not necessarily limited thereto.

The side lower member LM may absorb and disperse impact energy applied to the triple frame FF, which will be further described below.

The front subframe SF may be connected to the dash panel DP. The front subframe SF may be coupled to other structures located at the front portion of the vehicle body structure VB including the dash panel DP. The front subframe SF may support heavy components such as an engine, a transmission, a suspension, or the like of the vehicle VH. The front subframe SF may disperse weight and load of various components installed in the vehicle VH. The front subframe SF may absorb impacts and vibrations generated when the vehicle VH is driven, thereby improving ride quality and maintaining rigidity of the vehicle body.

Referring to FIGS. 1, 2, and 3, one side of the front subframe SF may be coupled to the subframe mounting member MM of the main frame MF. The subframe mounting member MM may be connected to the dash panel DP. The subframe mounting member MM may extend in a diagonal direction. The subframe mounting member MM may have an inclined shape. One side of the front subframe SF coupled to the subframe mounting member MM may be spaced apart from the triple frame FF in the second direction D2. Because the subframe mounting member MM can have an inclined structure and one side of the front subframe SF can be spaced apart from the triple frame FF in the second direction D2, a subframe separation space SP in which the front subframe SF may be separated in a diagonal downward direction, even when the vehicle VH collides, may be provided. When the vehicle VH collides, the front subframe SF may move to the subframe separation space SP, such that the front subframe SF, various components supported by the front subframe SF, or the like may not intrude into a space in which the passenger is riding.

FIG. 7 illustrates the vehicle body structure VB including the side lower member LM configured to absorb impact by a triangular structure. A side lower member LM according to an embodiment may have two arms divided by the branching region BA, and the two arms may be connected to each other as one arm. Therefore, the side lower member LM and the fourth cross member CM4 may have a triangular structure.

The first side lower member LM1 and the second side lower member LM2 may have a triangular structure, respectively, together with the fourth cross member CM4. The triangular structures located on both sides of the fourth cross member CM4 may offset moments caused by torsion of the vehicle VH due to a collision. A torsion angle of the main frame MF including the triple frame FF may be reduced by the triangular structure of the first side lower member LM1 and the triangular structure of the second side lower member LM2.

For a vehicle body structure VB according to example embodiments of the present disclosure, when the vehicle VH collides, the passenger may be safely protected. The vehicle body structure VB may absorb and disperse impact energy generated when the vehicle VH collides, by overlapping several structures. More specifically, the vehicle body structure VB may include the triple frame FF formed by the second cross member CM2, the fourth cross member CM4, and the battery pack BT. The triple frame FF may be at a position in which rotational moment typically occurs in a largest amount when the vehicle VH collides. Impact energy and rotational moment may be absorbed and dispersed in the vehicle body structure VB by the triple frame FF connected to the side sills SL at both sides. Impact energy may include rotational moment. Because the triple frame FF may be connected to the connection member CN and the side lower member LM, impact energy applied to the triple frame FF may be distributed by the connection member CN and the side lower member LM.

For a vehicle body structure VB according to example embodiments of the present disclosure, a bending phenomenon and a torsion phenomenon may be improved. Because the triple frame FF connects the side sills SL at both sides, rotational moment and sagging caused by bending load due to weight of the passenger or weight of the vehicle VH may be suppressed.

For a vehicle body structure VB according to example embodiments of the present disclosure, the driving economy of the vehicle VH may be improved. The fourth cross member CM4 and the side sill SL may form the sealing surface PP having the same level. The battery pack BT may be in contact with the sealing surface PP, and may be coupled to the fourth cross member CM4 and the side sill SL. By simplifying a coupling surface of the battery pack BT, the fourth cross member CM4, and the side sill SL, an assembly operation may be simplified, and sealing performance may be also improved, which may improve noise-vibration-harshness (NVH) performance. By securing rigidity of the vehicle body structure VB, even with deleting a central floor panel between side sills SL, which can be present in advance, weight of the vehicle VH may be reduced to improve driving stability such as handling performance or the like, to increase a driving distance of an electric vehicle, and to reduce wear of components such as a tire or the like.

A vehicle body structure according to an embodiment of the present disclosure may improve side collision stability by including a first cross member and a second cross member.

A vehicle body structure according to an embodiment of the present disclosure may absorb impact by locating a triple structure in a position in which a rotational moment caused by a collision load is typically large.

A vehicle body structure according to an embodiment of the present disclosure may disperse stress applied to a triple structure by a connection member and a side lower member.

A vehicle body structure according to an embodiment of the present disclosure may reduce weight of a vehicle and improving air-tightness performance by simplifying a sealing surface of a battery pack.

A number of embodiments have been disclosed herein. It is understood that various features of the different embodiments can be combined. While example embodiments have been shown and described above, it can be apparent to those skilled in the art that modifications, variations, and equivalents thereof could be made without departing from the scopes of the present disclosure as defined by the appended claims.

1. A vehicle body structure comprising:
a dash panel;
a side sill including a first side sill and a second side sill, respectively connected to both sides of the dash panel;
a first cross member located above the side sill and coupled to the dash panel;
a second cross member coupled to the dash panel and connected to the side sill; and
a connection member connecting the first cross member and the second cross member,
wherein the connection member includes:
a first connection member, and
a second connection member spaced apart from the first connection member.

2. The vehicle body structure of claim 1, wherein the first cross member and the second cross member are coupled to the dash panel,
wherein a first level of the first cross member is higher than a second level of the second cross member, and
wherein the first cross member and the second cross member are spaced apart in an extension direction of the side sill.

3. The vehicle body structure of claim 1, wherein a battery space is provided between the first side sill and the second side sill, and wherein the vehicle body structure further comprises:
a third cross member spaced apart from the second cross member, and
a battery pack installed in the battery space, wherein the third cross member is coupled to an upper surface of the battery pack.

4. The vehicle body structure of claim 3, further comprising a third connection member connecting the first cross member, the second cross member, and the third cross member,
wherein the third connection member penetrates the second cross member.

5. The vehicle body structure of claim 4, wherein the third connection member is located between the first connection member and the second connection member.

6. The vehicle body structure of claim 1, further comprising a fourth cross member overlapping the second cross member below the second cross member.

7. The vehicle body structure of claim 6, wherein the fourth cross member is connected to the first side sill and the second side sill, and
wherein a fourth-cross-member lower surface of the fourth cross member, a first-side-seal lower surface of the first side sill, and a second-side-seal lower surface of the second side sill together provide a sealing surface having a constant level.

8. The vehicle body structure of claim 7, further comprising a battery pack located between the first side sill and the second side sill, wherein the battery pack overlaps the sealing surface, and wherein the battery pack is connected to the fourth cross member.

9. The vehicle body structure of claim 6, further comprising a side lower member coupled to the fourth cross member, wherein the side lower member has a branching region, and wherein the side lower member is connected to the fourth cross member in a plurality of regions.

10. The vehicle body structure of claim 9, wherein the side lower member comprises:
a first side lower member; and
a second side lower member spaced apart from the first side lower member.

11. The vehicle body structure of claim 1, further comprising:
a subframe mounting member connected to the dash panel; and
a front subframe connected to the subframe mounting member below the first cross member.

12. The vehicle body structure of claim 11, wherein the subframe mounting member extends in a diagonal direction.

13. The vehicle body structure of claim 12, further comprising a fourth cross member overlapping the second cross member below the second cross member,
wherein the first cross member extends in a first direction,
wherein the front subframe and the fourth cross member are spaced apart in a second direction, and
wherein the second direction intersects the first direction.

14. A vehicle body structure comprising:
a dash panel;
a first side sill connected to a first side of the dash panel;
a second side sill connected to a second side of the dash panel;
a triple-frame structure comprising:
a first triple-frame-structure cross member coupled to the dash panel, connected to the first side sill, and connected to the second side sill, wherein the first triple-frame-structure cross member extends between the first side sill and the second side sill,
a second triple-frame-structure cross member below the first triple-frame-structure cross member and abutting the first triple-frame-structure cross member, wherein the second triple-frame-structure cross member is connected to the first side sill and the second side sill, and wherein the second triple-frame-structure cross member extends between the first side sill and the second side sill, and
a battery pack adjacent the second triple-frame-structure cross member, wherein the battery pack is disposed between the first side sill and the second side sill.

15. The vehicle body structure of claim 14, wherein a second-triple-frame-structure-cross-member lower surface of the second triple-frame-structure cross member, a first-side-seal lower surface of the first side sill, and a second-side-seal lower surface of the second side sill together provide a sealing surface having a constant level.

16. The vehicle body structure of claim 15, wherein the battery pack overlaps the sealing surface, and wherein the battery pack is connected to the second triple-frame-structure cross member.

17. The vehicle body structure of claim 14, further comprising:
a first cross member located above the first side sill, above the second side sill, and coupled to the dash panel;
a first connection member connecting the first cross member and the first triple-frame-structure cross member; and
a second connection member connecting the first cross member and the first triple-frame-structure cross member, wherein the second connection member is spaced apart from the first connection member.

18. The vehicle body structure of claim 17, wherein a first level of the first cross member is higher than a second level of the first triple-frame-structure cross member, and
wherein the first cross member and the first triple-frame-structure cross member are spaced apart in a first diagonal direction.

19. The vehicle body structure of claim 18, further comprising:
a subframe mounting member connected to the dash panel, wherein the subframe mounting member extends in a second diagonal direction; and
a front subframe connected to the subframe mounting member below the first cross member.

20. A vehicle body structure comprising:
a dash panel;
a first side sill connected to a first side of the dash panel;
a second side sill connected to a second side of the dash panel, wherein a battery space is provided between the first side sill and the second side sill;
a first cross member located above the first side sill, located above the second side sill, and coupled to the dash panel;
a second cross member coupled to the dash panel, connected to the first side sill, and connected to the second side sill, wherein the second cross member extends between the first side sill and the second side sill, wherein the first cross member is spaced apart from the second cross member in a first diagonal direction, and wherein a first level of the first cross member is higher than a second level of the second cross member;
a first connection member connecting the first cross member and the second cross member;
a second connection member connecting the first cross member and the second cross member, wherein the second connection member is spaced apart from the first connection member in a width direction;
a third cross member spaced apart from the second cross member in a length direction, wherein the length direction intersects the width direction;
a battery pack installed in the battery space, wherein the third cross member is coupled to a battery-pack upper surface of the battery pack;
a third connection member connecting the first cross member, the second cross member, and the third cross member, wherein the third connection member penetrates the second cross member, and wherein the third connection member is located between the first connection member and the second connection member; and
a fourth cross member overlapping the second cross member below the second cross member,
wherein the fourth cross member is connected to the first side sill and the second side sill,
wherein a fourth-cross-member lower surface of the fourth cross member, a first-side-seal lower surface of the first side sill, and a second-side-seal lower surface of the second side sill together provide a sealing surface having a constant level,
wherein the battery pack overlaps the sealing surface,
wherein the battery pack, the second cross member, and the fourth cross member together provide a triple-frame structure, and
wherein a triple-frame space is enclosed between the second cross member and the fourth cross member.
